(19) United States
(12) Patent Application Publication
(10) Pub. No.: US 2013/0287541 A1
(43) Pub. Date: Oct. 31, 2013

(54) TRUNNION BAR RESTRAINING SYSTEM FOR REAR LOADING GARBAGE TRUCKS

(71) Applicants: Fred P. Smith, Alpine, UT (US); David G. Smith, Alpine, UT (US)

(72) Inventors: Fred P. Smith, Alpine, UT (US); David G. Smith, Alpine, UT (US)

(21) Appl. No.: 13/874,310

(22) Filed: Apr. 30, 2013

Related U.S. Application Data
(60) Provisional application No. 61/640,661, filed on Apr. 30, 2012.

(51) Int. Cl. F16M 13/02; B65F 3/02

(52) U.S. Cl. CPC F16M 13/02; B65F 3/02
USPC 414/810; 248/205.1

(57) ABSTRACT

This application discloses trunnion bar retention systems, the systems may include a pair of holding pieces configured to be coupled to a garbage truck; and a stop formed in each of the holding pieces configured to substantially prevent a trunnion bar from exiting the retention system in response to operation of the packing panels when a container is dumped into the garbage truck, wherein the stop is fixedly attached to the holding piece. In some embodiments, the stop and the holding piece form a trunnion pocket. The system may further include a locking bar pivotably coupled to each of the pair of holding pieces, and a latch coupled to each of the pair of holding pieces, the latches being configured to selectively secure the locking bars to the holding pieces.

### PRIORITY

This application claims priority to U.S. Provisional Patent Application No. 61/640,661, entitled: Trunnion Bar Restraining System for Rear Loading Garbage Trucks, and filed on Apr. 30, 2012, which is incorporated herein by reference in its entirety.

### FIELD

This application relates generally to refuse collection and disposal equipment. More specifically, this application relates to relates to trunnion bar restraining systems for rear loading refuse trucks.

### BACKGROUND

Community refuse or garbage collection and disposal is a key component of modern civilization. Each day in the United States, tens of thousands of garbage trucks move to all corners of the country, with a garbage truck visiting virtually every home and business at least once each week. Over time, garbage collection has evolved to employ better technologies to provide efficiency and safety during the garbage collection and disposal.

In 1938 the first rear loading packing garbage truck was developed. In 1958 Garwood came out with the first hydraulic “kick bar” container hoist on the LP-500 for lifting up to 1.5 cubic yard containers. By the early 1960's rear loaders were using cable winches to empty large dumpsters into the rear loader. These containers utilized a trunnion bar across the front top of the container. The trunnion bar sticks out past each edge of the container. Each side of the trunnion bar engages a holding piece on the rear loader. The winch cable pulls the container up and the forces are such that the trunnion bar is held in the holding piece. In the early days of dumping containers with a winch, many trucks had no locking bars to secure the trunnion bar in the holding piece. Trucks that used a “kick bar” or “roll bar” to raise the container, on the other hand, had trunnion locking bars and latches as they were necessary to dump a container with the kick bar. Later as a safety measure all rear loaders came with trunnion locking bars and latches even if they only utilized the winch for dumping.

FIG. 1 illustrates a current rear-loading garbage truck 10 for reference purposes of the various components and functionality of the garbage truck. Garbage truck 10 may include hopper 20, packer panels 21, hopper lip 25, tip bar 30, cable 35, driven by winch 37 and having a hook 36 to attach to containers. Holding piece 1 and locking bars 2 may be used to secure a trunnion bar of a garbage container when being emptied. FIG. 2 illustrates an example of a current holding piece 1 positioned as it would for use with locking bars 2 on a garbage truck 10 to hold a trunnion bar of a waste container.

If the trunnion locking bars 2 and latches are not secured and the packing panels in hopper 20 are cycled while the container is still elevated, enough force in the right direction can be generated by the packing panels 21 and refuse to push the trunnion bar away from the holding piece past the hopper lip 25, dislodging it from holding piece the back of the truck. If both sides of the trunnion bar are dislodged at the same time the container falls to the ground. If the passenger's side trunnion bar is dislodged, that side falls to the ground usually dislodging the driver's side of the trunnion bar. The momentum gained during that fall can cause the container to pivot around the end of the trunnion bar on the ground and swing on the cable around to the side of the truck were the operator is standing, potentially injuring and/or killing the operator or anyone standing nearby; this is known as “container swing.”

Several operators have been injured and killed in the past by container swing. Container swing is such a well known, catastrophic problem that OSHA issued a bulletin specific to this problem that recommends the container be lowered to the ground before actuating the packing panels 21. Although this would eliminate the container swing, it is time consuming, and therefore many users will not do it. There are also times when the operator either forgets or for some other reason does not secure the locking bars and latches around the trunnion bar. Without the locking bars 2 latched in place, the trunnion bar can be pushed out in response to operation of the packing panels 21.

There are several mechanisms that have been used to address container swing on rear loading garbage trucks. The first are the trunnion locking bars 2 and latches that now come standard on all rear loading refuse trucks with commercial container dumping capability. These are designed to hold a trunnion bar from being pushed out of the holding piece in place while the container is elevated either by winch cable or buy a kick bar. There are two locking bars 2 and two latches, one of each on either side of the hopper 20. The locking bar pivots near the hopper sill of the truck and the latch holds the locking bar in the raised position to lock it behind the trunnion bar. Despite these devices, garbage trucks using holding piece 1 and locking bars 2 have still experienced container swing resulting in serious injuries and death. The difficulty is that it takes time and effort to secure the locking bars and latches on both sides of the truck and because it is not necessary to secure the locking bars in order to dump a container with a winch cable, the locking bars and latches may be left undone. Other devices such as the applicant's U.S. Pat. No. 5,006,030 have attempted to use hydraulic power to latch the trunnion bar to the truck. These devices are expensive and heavy and reduce the payload of the garbage truck considerably.

### SUMMARY

In normal operation the combination of the weight of the container and the force of the winch cable to raise the container, forces the trunnion bar into the trunnion pocket at the bottom of the holding piece. Since a typical container may hold significantly more refuse than the hopper of the garbage truck can hold, it is not uncommon for the operator to cycle the packer panels while the container is raised up in the air. If the packer panels are cycled while the container is raised, it is possible for them or garbage they are pushing, to push on the container trunnion or the container itself. If the force is sufficient, it may push the trunnion out of the pocket at the bottom of the holding piece, disengaging it from the truck. The direction of the force on the trunnion or container is limited by the direction of movement of the packer panels when they are opening. Although it will vary depending on the construction of the particular packer panels and the material being pushed by them, the maximum angle that can be exerted on the trunnion bar or container is generally less than 40° above horizontal to the rear. Yet, if the trunnion bar can slide forward of the hopper lip in the holding piece when the container is being raised, when the container is lowered, the container rotates around the hopper lip raising the trunnion bar in an almost vertical direction. The present invention makes use of this difference in direction of the forces to keep the trunnion bar from being pushed out of the container retention system when subject to the forces that the packer panels can exert, yet allows the trunnion bar to come out when the container is lowered.

This application discloses trunnion bar retention systems, the systems may include a pair of holding pieces configured to be coupled to a garbage truck; and a stop formed in each of the holding pieces configured to substantially prevent a trunnion bar from exiting the retention system when a container is dumped into the garbage truck and pushed rearward in response to the action of the packer panels, wherein the stop may be fixedly attached to, or integrally formed with the holding piece. In some embodiments, the stop and the holding piece form a trunnion pocket. The stop may include a portion that is at a steep enough angle that the trunnion bar cannot be pushed past it when considering the weight of the container, the coefficient of friction of the trunnion on the holding piece, the force exerted on the container by the packer panels and the force of the cable on the container. This will be discussed in detail later. The system may further include a locking bar pivotably coupled to each of the pair of holding pieces or elsewhere to the rear of the garbage truck, and a latch coupled to each of the pair of holding pieces, the latches being configured to selectively secure the locking bars to the holding pieces.

In some embodiments, trunnion bar retention systems may be used by providing a rear-loading garbage truck having a trunnion bar retention system; backing the garbage truck to a refuse container having a trunnion bar; lifting a portion of the refuse container with a cable or other means such that trunnion bar contacts a portion of the trunion bar retention system such that the container rotates about the hopper lip; sliding the trunnion bar into a trunnion pocket at which point the container will rotate about the trunnion bar; the trunnion pocket formed in the trunnion bar retention system with a holding piece and a stop, the stop being formed such that the trunnion bar cannot slide out of the trunnion bar retention system when the trunnion bar is primarily bearing the weight of the refuse container and is being pushed rearward in response to the action of the packer panels; and lowering the refuse container until a portion of the refuse container other than the trunnion bar pivots against a portion of the garbage truck lifting the trunnion bar over the stop and out of the trunnion pocket.

In some embodiments, trunnion bar retension systems may be used by providing a rear loading garbage truck a trunnion bar retention system; backing the garbage truck to a refuse container having a trunnion bar; latching the trunnion bar into the trunnion bar retension system with locking bars and latches; rotating the container with a kick bar such that as the container is raised, the trunnion slides down into a trunnion pocket at which point the container will rotate about the trunnion bar; the trunnion pocket formed in the trunnion bar retention system with a holding piece and a stop, the stop being formed such that the trunnion bar cannot slide out of the trunnion bar retention system when the trunnion bar is primarily bearing the weight of the refuse container and is being pushed rearward in response to the action of the packer panels; and lowering the refuse container until a portion of the refuse container other than the trunnion bar pivots against a portion of the garbage truck lifting the trunnion bar over the stop and out of the trunnion pocket.

### BRIEF DESCRIPTION OF THE DRAWINGS

The following description can be better understood in light of the Figures, in which:

FIG. 1 shows a current version of a rear-loading garbage truck;

FIG. 2 shows a current version of a holding piece used on a rear-loading garbage truck;

FIGS. 3-4 show an exemplary holding piece and trunnion bar restraining system;

FIGS. 5-6 show an exemplary holding piece and trunnion bar restraining system;

FIGS. 7-8 show an exemplary holding piece and trunnion bar restraining system;

FIGS. 9-11 show an exemplary trunnion bar restraining system in use with a rear-loading garbage truck;

FIGS. 12-17 show the progression of the functionality of an exemplary trunnion bar restraining system when a container is raised for dumping using a cable;

FIGS. 18-22 show the progression of the functionality of an exemplary trunnion bar restraining system when a container is lowered after dumping;

FIG. 23 is a force diagram for an exemplary trunnion bar restraining system; and

FIGS. 24-33 show the progression of the functionality of an exemplary trunnion bar restraining system when a container is dumped using a tip bar.

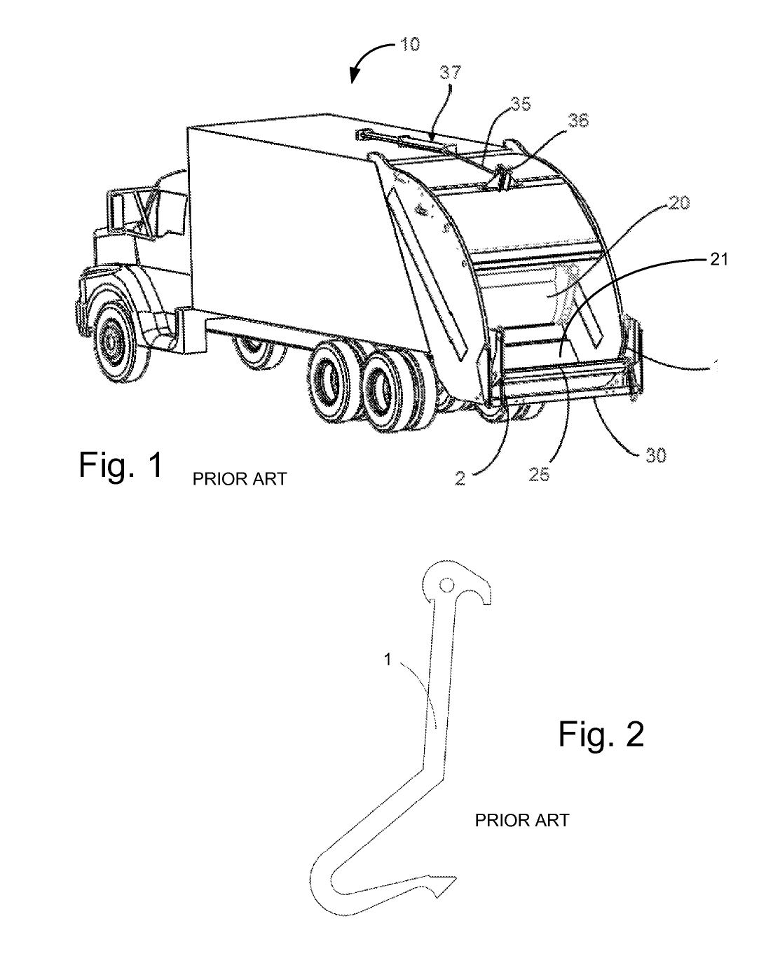

The Figures illustrate specific aspects of exemplary trunnion bar restraining systems and methods for making and using such devices as described below. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices. Moreover, the Figures may show simplified or partial views, and the dimensions of elements in the Figures may be exaggerated or otherwise not in proportion for clarity.

### DETAILED DESCRIPTION

The following description supplies specific details in order to provide a thorough understanding. Nevertheless, the skilled artisan would understand that the described trunnion bar restraining systems and methods of restraining container trunnion bars can be implemented and used without employing these specific details. Indeed, the trunnion bar restraining systems and associated methods can be placed into practice by modifying the illustrated devices and methods and can be used in conjunction with any other apparatus and techniques conventionally used in the industry.

In addition, as the terms on, attached to, or coupled to are used below, for clarity of describing function, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, forward, rearward, sideward, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

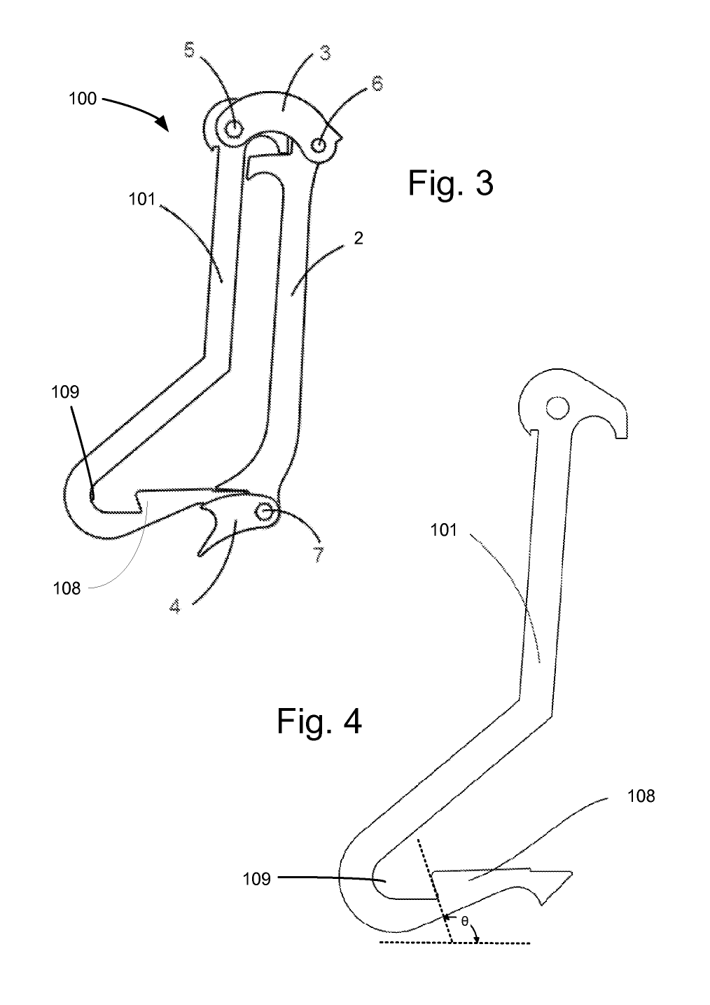

Some embodiments of the exemplary trunnion bar restraining systems and methods of making and using these systems are described in detail below and illustrated in the Figures. FIG. 3 illustrates improved trunnion bar retention system 100, which may include holding piece 101, locking bar mount 4, locking bar 2, and latch 3. Holding piece 101 may be coupled to a garbage truck 10 by means such as welding. Locking bar 2 may be rotatably coupled to locking bar mount 4 with locking bar bolt 7. Latch bolt 5 may connect latch 3 to holding piece 101. Latch 3 may be rotatably coupled to holding piece 101 such that latch 3 may rotate about latch bolt 5 to allow selective latching with locking bar 2. Latch pin 6 may engage a groove on the rear side of locking bar 2 to secure locking bar 2 in place when used as described below.

Similarly, holding piece 101 may be placed against other portions of garbage truck 10, or other elements to keep it stationary and fixed to garbage truck 10, such as locking bar mount 4, which may be also attached to garbage truck 10 by welding, bolting, or any other attachment process, or by placement against other components of garbage truck 10, such as hopper lip 25, and/or bolted to garbage truck 10. Locking bar bolt 7 may pivotably couple locking bar mount 4 to locking bar 2, such that locking bar 2 may rotate about locking bar bolt 7.

Holding piece 101 may also include stop 108 and trunnion pocket 109. Holding piece 101 may be formed generally to provide an open slot ending with trunnion pocket 109 to receive trunnion bar 41 (shown in subsequent Figures). Stop 108 may be a portion of holding piece 101 which resists exit of trunnion bar 41 from trunnion pocket 109 when pushed along a bottom of trunnion pocket 109 in response to the force 19 of the packer panels, requiring instead that trunnion bar 41 be lifted upwardly to avoid stop 108 to be withdrawn from trunnion pocket 109.

As shown in FIG. 4, stop 108 may be formed such that it forms a surface or effective ledge at an angle θ to horizontal, which thereby resists the egress of trunnion bar in trunnion pocket 109 without being lifted over stop 108. The force exerted on the container or container trunnion φ by the packer panels may vary depending on the construction of the packer panel but will generally be less than 40 degrees from horizontal due to the configuration of the packer panels, hopper, trunnion and container. When the container is raised by a winch cable, the forces that can act on the trunnion bar are the container weight, the cable force and the packer panel force 19. Both the cable force and the container weight act in a direction that tends to keep the container trunnion in the trunnion pocket 109. Therefore, these forces can be neglected and be conservative in determining what the stop angle θ must be in relation to panel force φ such that the trunnion cannot ride over the stop 108 in reaction to packer panel force 19.

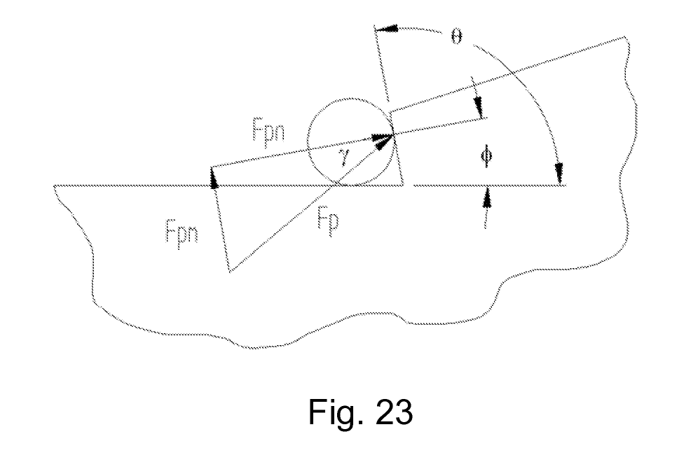

Referring now to FIG. 23, Fp is the force exerted on the trunnion, packer panel force 19, Fpn is the normal component of Fp to the stop 108 and Fpm is the component of Fp that would move the trunnion over the stop. From geometry γ=90°+φ−θ. The trunnion bar can be pushed over the stop when Fpm is greater than the friction force μFpn. Written in terms of Fp, this would be Fp sinγ=μFp cosγ. Solving for μ, μ=tanγ. A typical value for μ for steel on steel would be 0.6, thus tan⁻¹ (0.6)=90°+φ−θ. Generically then, the stop angle θ=90°−31°+φ, or θ=59°+φ As previously mentioned, in some embodiments the maximum angle (φ) of the packer panel force 19 (Fp) is 40°, therefore for those embodiments, the angle of the stop which would not allow the trunnion bar to move over the stop would be θ=59°+40°, or θ=99°. In other embodiments where the packer panel force is at a different maximum angle, the stop angle may change accordingly. Generally, depending on the highth and of stop 108, the larger the value of angle θ (up to φ+90 degrees), the more secure trunnion bar 41 may be in trunnion pocket 109 in preventing container swing events.

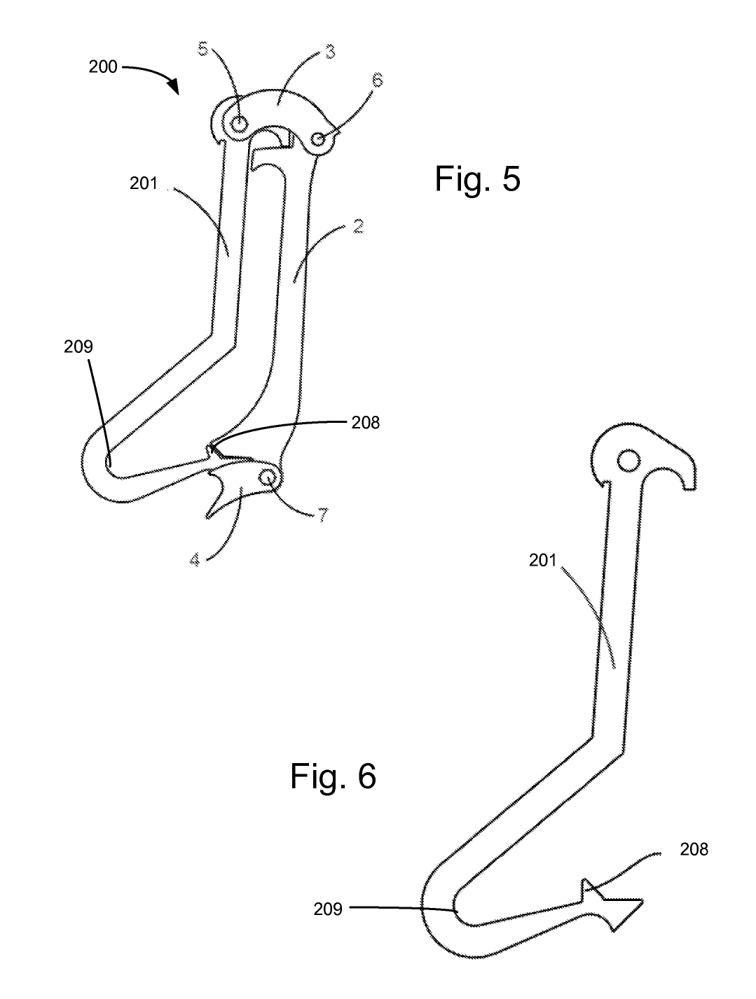

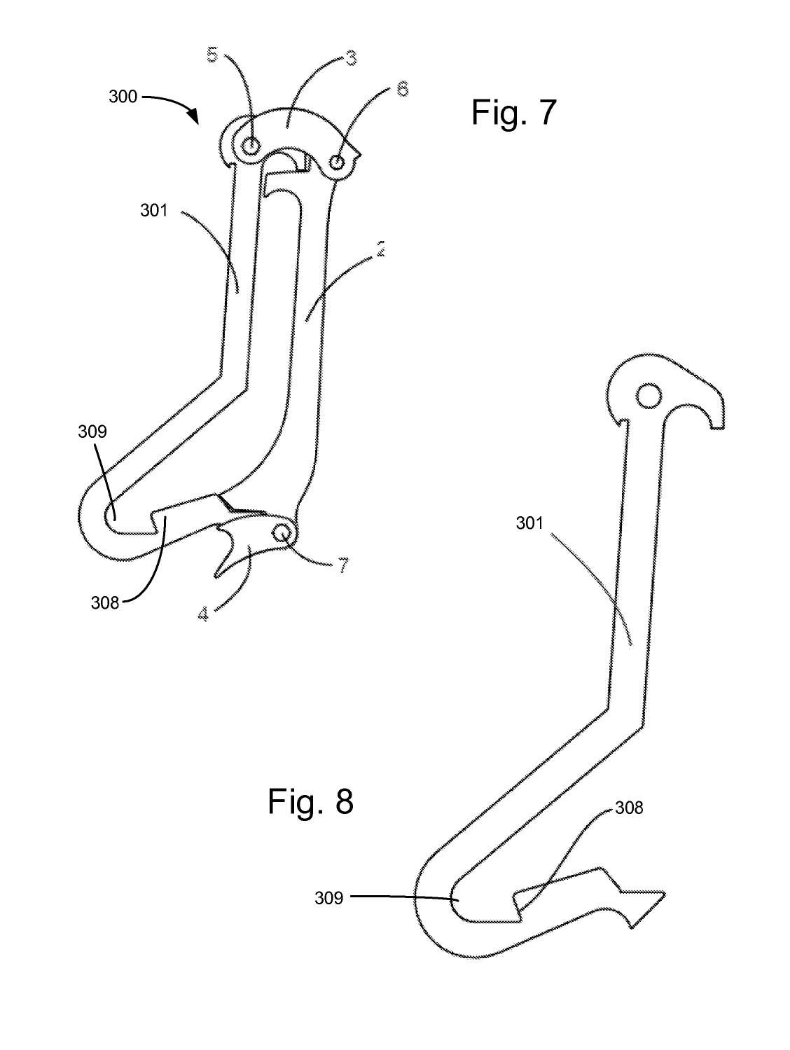

FIGS. 5 and 6 show alternative embodiment of trunnion bar retention system 200, with stop 200 on holding piece 201. Similarly, FIGS. 7 and 8 illustrate stop 308 on holding piece 301 of another exemplary trunnion bar retention system 300. The embodiments of trunnion bar retention systems 200, 300, generally function is the same manner as trunnion bar retention system 100, as used in the subsequent drawings and described in this document.

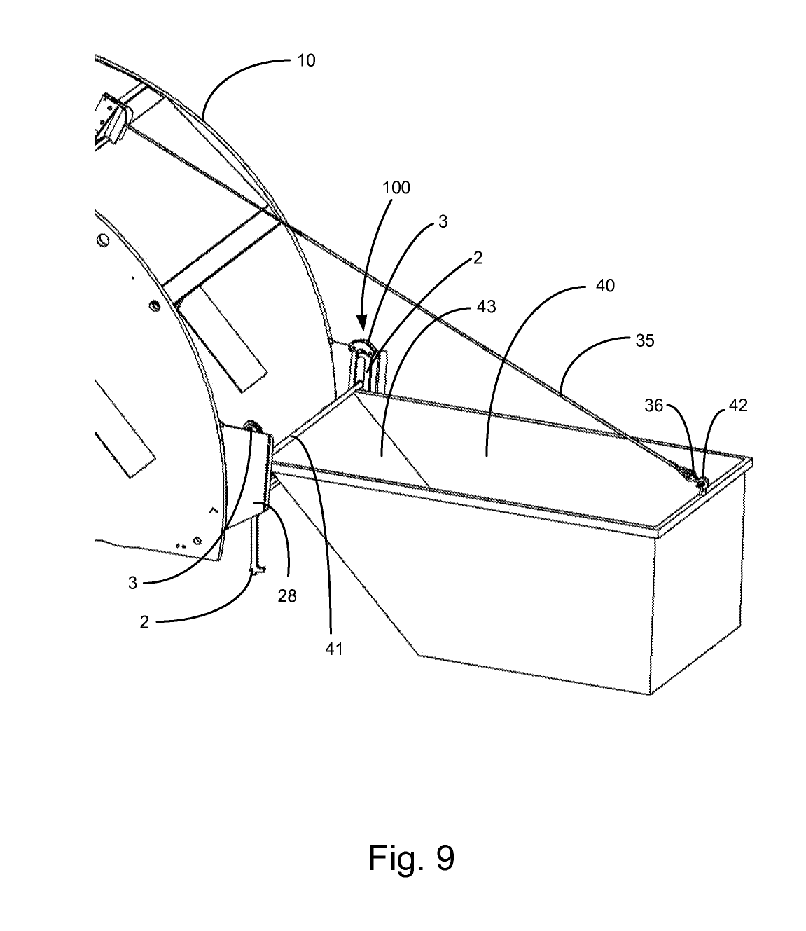

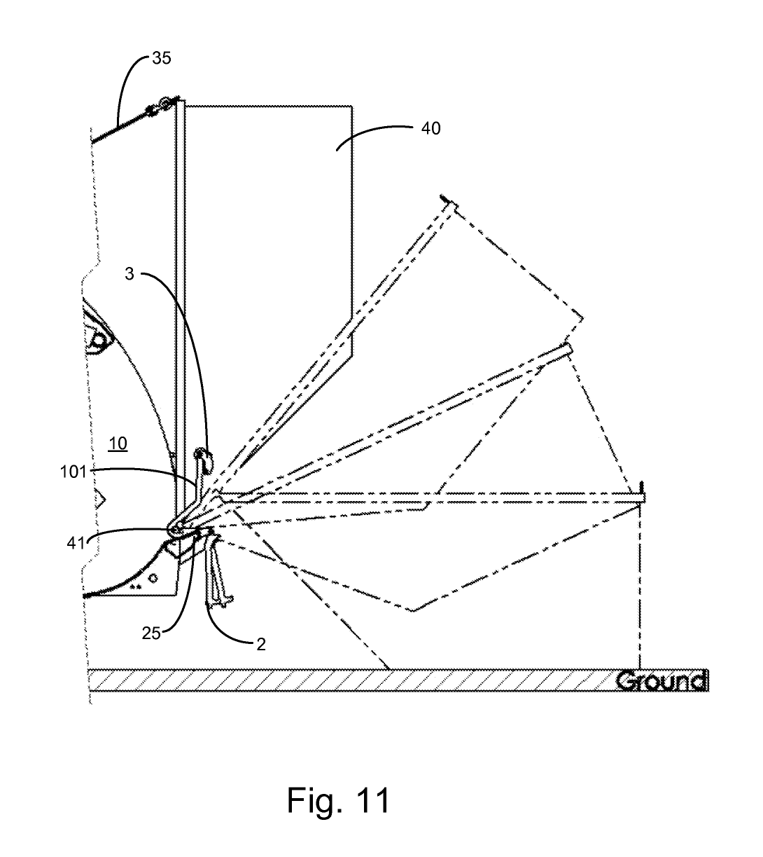

FIGS. 9-11 generally illustrate a perspective view of garbage truck 10 with trunnion bar retention system 100 restraining the trunnion bar while container 40 is being emptied. In the Figures, one of the locking bars 2 is not secured as if dislodged or forgotten for illustration purposes. A rear loading garbage truck 10 may empty commercial containers 40 with winch 37 as follows: the driver may approach container 40 in reverse until trunnion bar 41 of container 40 is close to the holding piece 101 of trunnion bar retention system 100. Self centering devices, such as elephant ears 28, on truck 10 may guide trunnion bar 41 on container 40 to the proper position side to side. The driver may then exit the vehicle and attach hook 36 of cable 35 at the far end, center of the container at hook attachment 42.

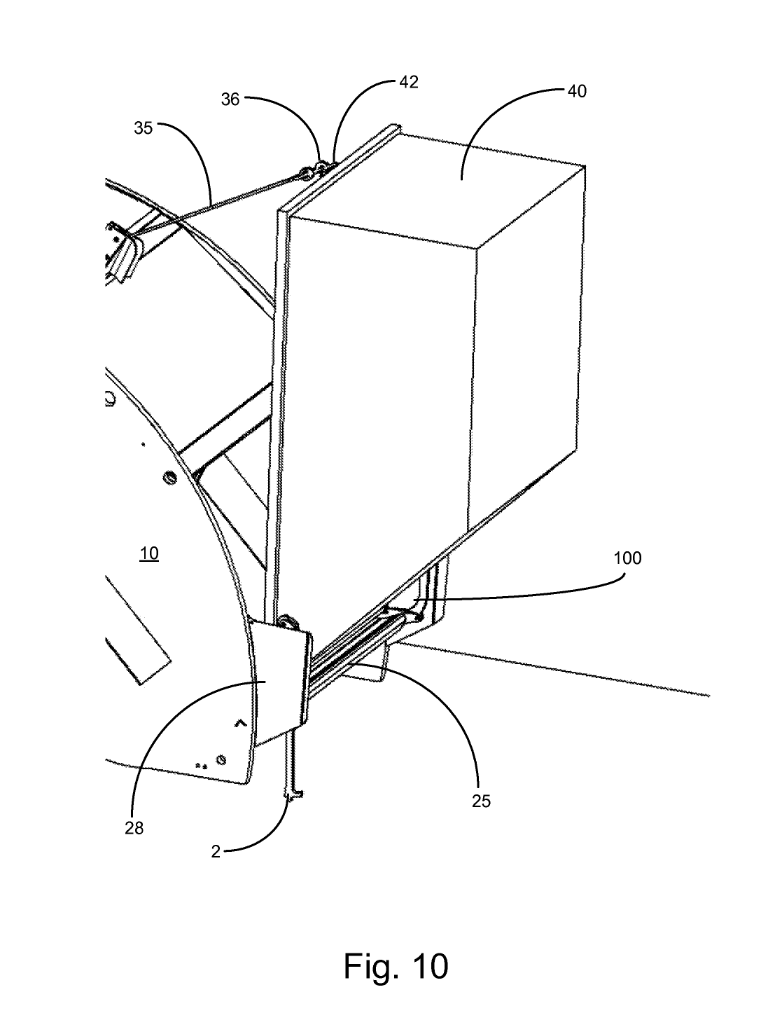

The driver may then secure locking bars 2 around trunnion bar 41 with latch 3. Cable 37 may then be retracted with a winch, raising the far end of the container off of the ground, as shown in FIG. 10. Trunnion bar 41 may then pivot in trunnion pockets 109 of each holding piece 101. As the rear of container 40 raises, the garbage may fall from container 40 into hopper 20. Container 40 may have more capacity than hopper 20 of garbage truck 10 and material must be cleaned out of hopper 20 so that container 40 can be fully emptied. To do this, the hydraulic packing panels 21 may be used to move the garbage from hopper 20 to the body of the truck. After container 40 is emptied, cable 35 may be let out to lower container 40 back to the ground.

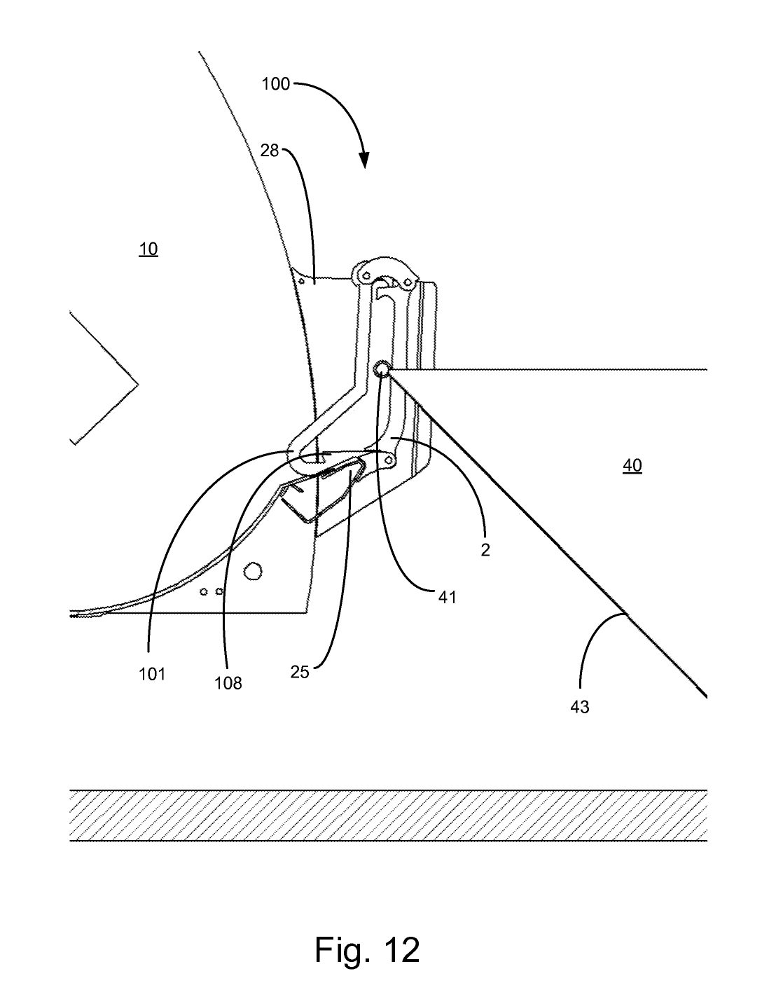

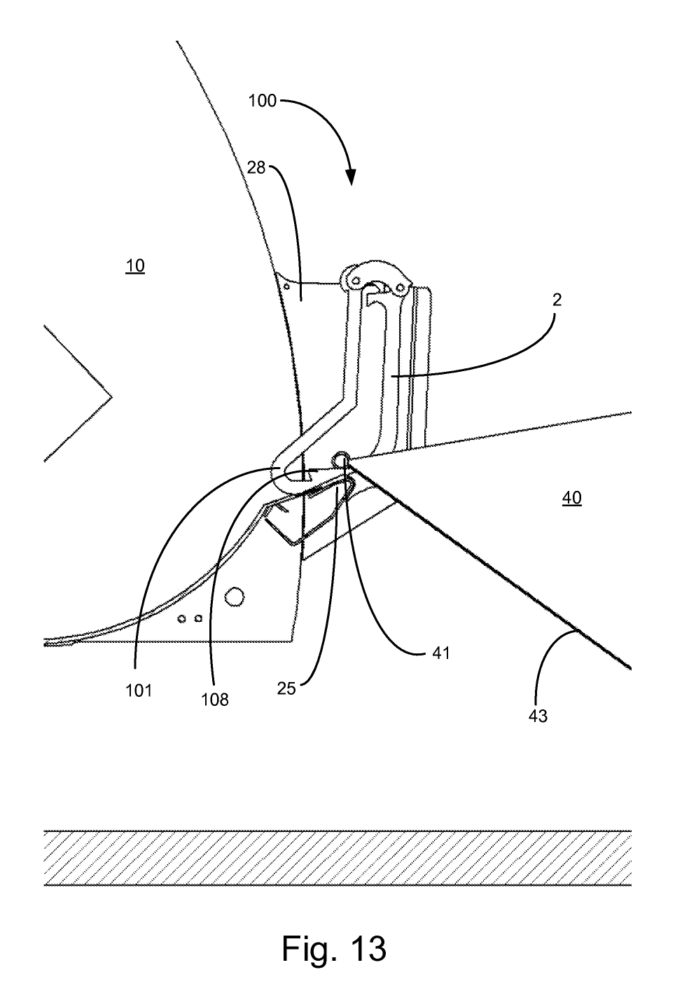

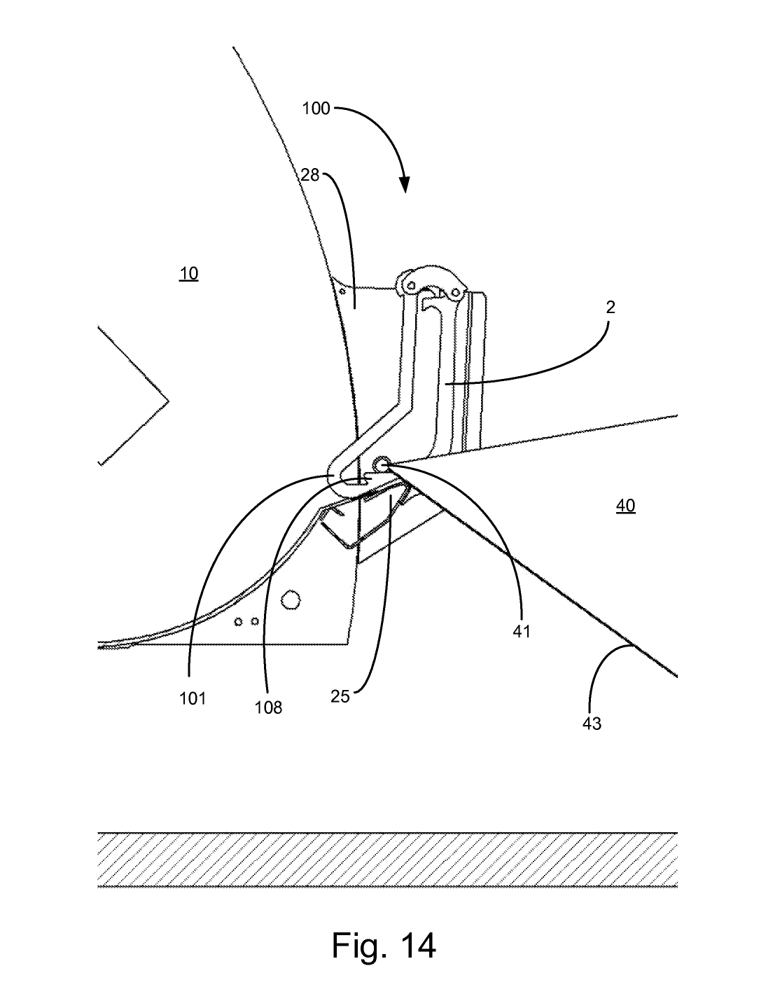

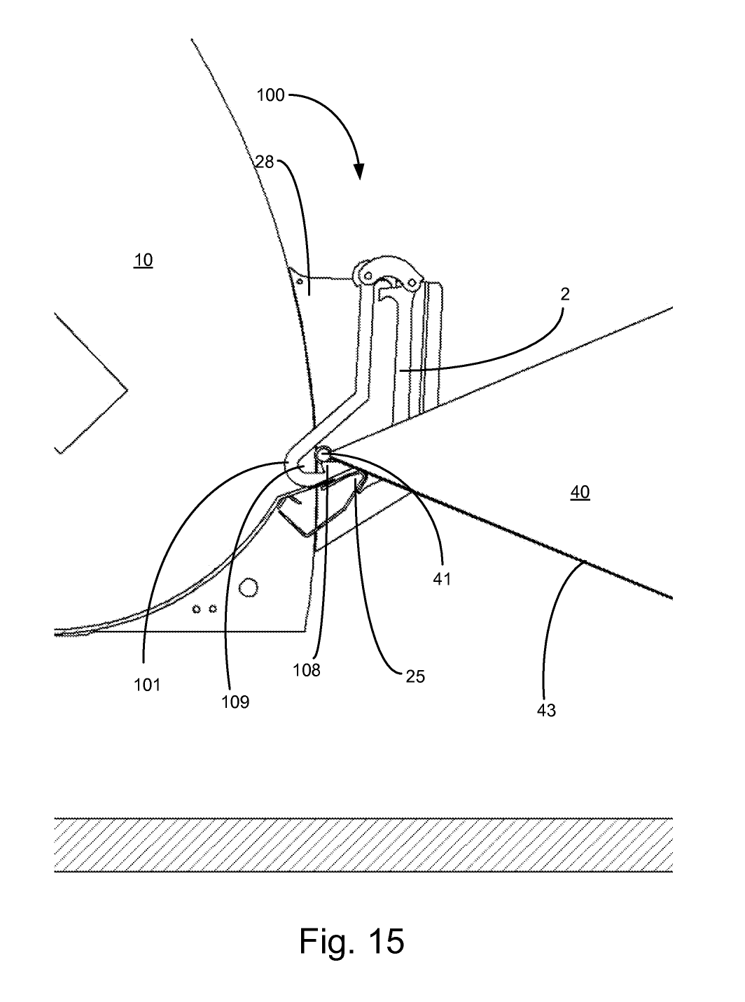

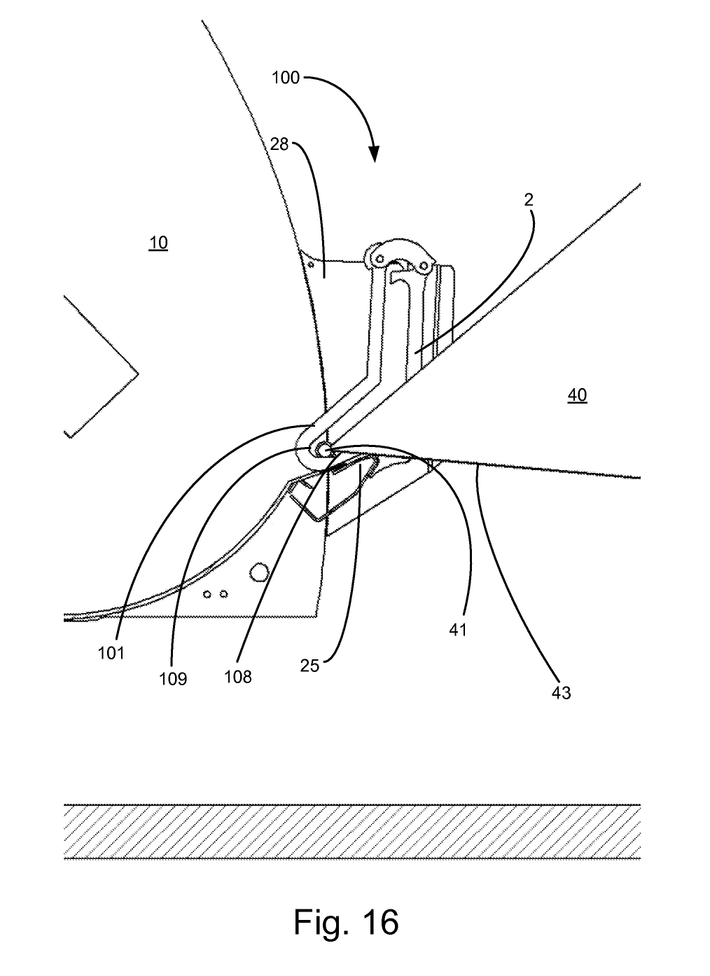

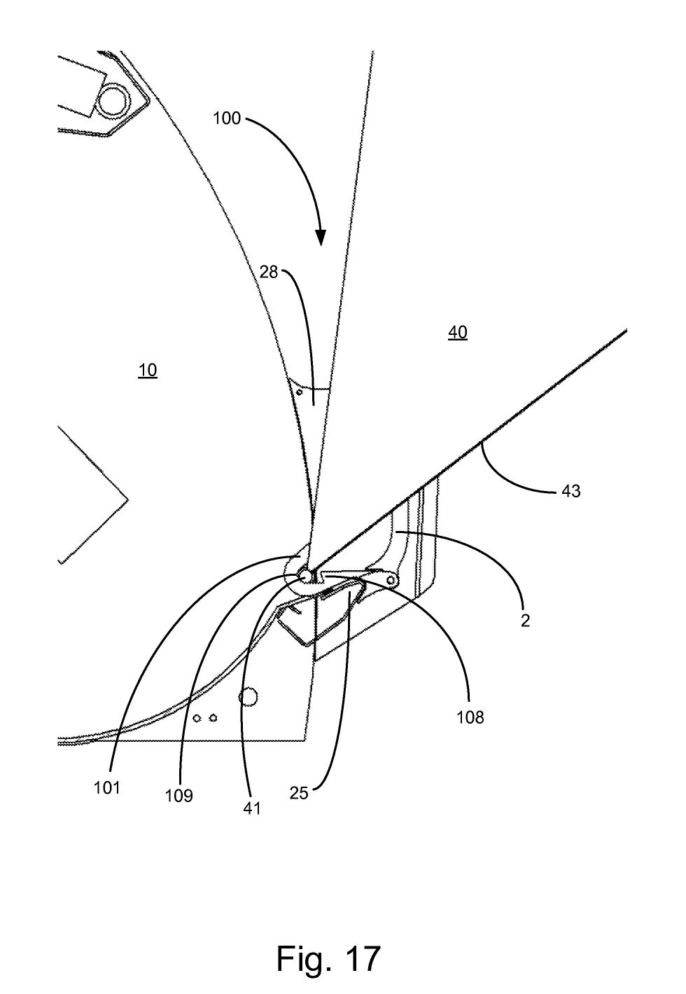

FIGS. 12-17 illustrate the functionality of trunnion retaining system 100 when raising container 40 to be emptied. As shown in FIG. 12, trunnion bar 41 may be secured in a space between holding piece 101 and locking bar 2 prior to lifting container 40. As container 40 is lifted it may initially rotate about the hopper lip, trunnion bar 41 then dips and contacts a lower portion of holding piece 101. As container 40 is further lifted, container 40 pivots around trunnion bar 41, and trunnnion bar 41 is pushed towards trunnion pocket 109. Trunnion bar 41 may eventually push past stop 108 and into trunnion pocket 109 because of the downward slope of the top of stop 108 and cable 35 is pulling container 40 towards garbage truck 10.

During the lifting process, once trunnion bar 41 contacts portions of holding piece 101, container 40 may rotate about the fulcrum of trunnion bar 41. Once trunnion bar 41 slips past stop 108 and into trunnion pocket 109, stop 108 may then prevent trunnnion bar 108 from sliding back out along the bottom of holding piece 101. For example, if packing panels 21 are engaged when container 40 is elevated, stop 108 may prevent trunnion bar 41 from exiting trunnion pocket 109 in response to operation of the packing panels 21. Thus, as long as the angle of the stop is sufficient as compared with the packing panel force 19, it may be very difficult, if not impossible to push trunnion bar 41 out of trunnion pocket 109, even when packing panels 21 of garbage truck 20 push garbage against wall 43 and trunnion bar 41 of container 40.

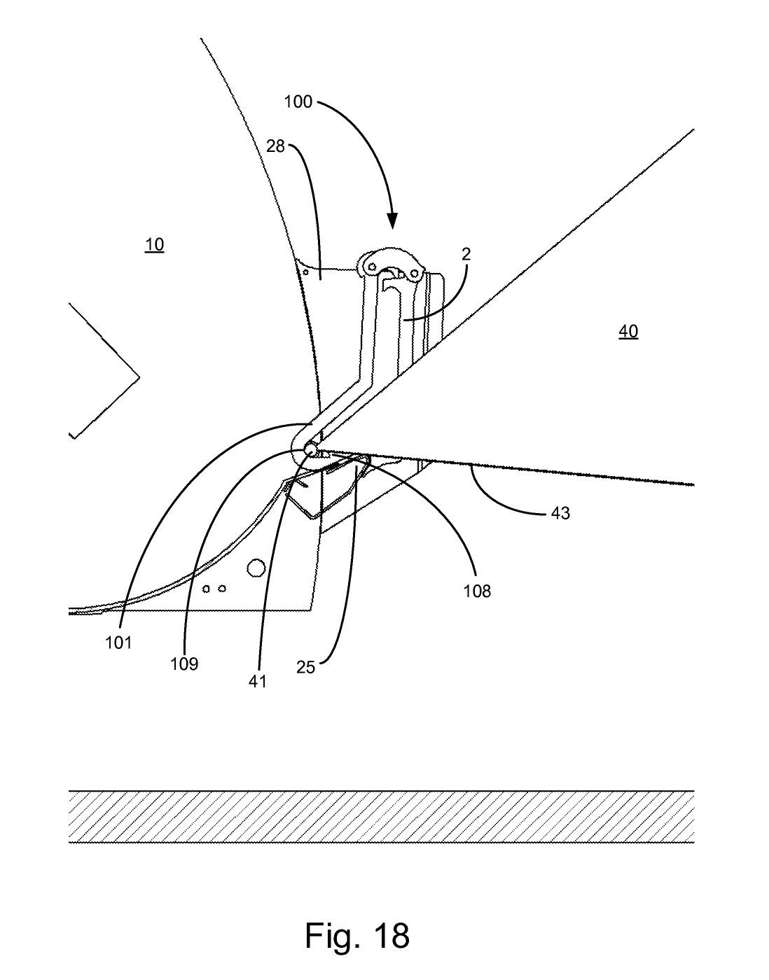

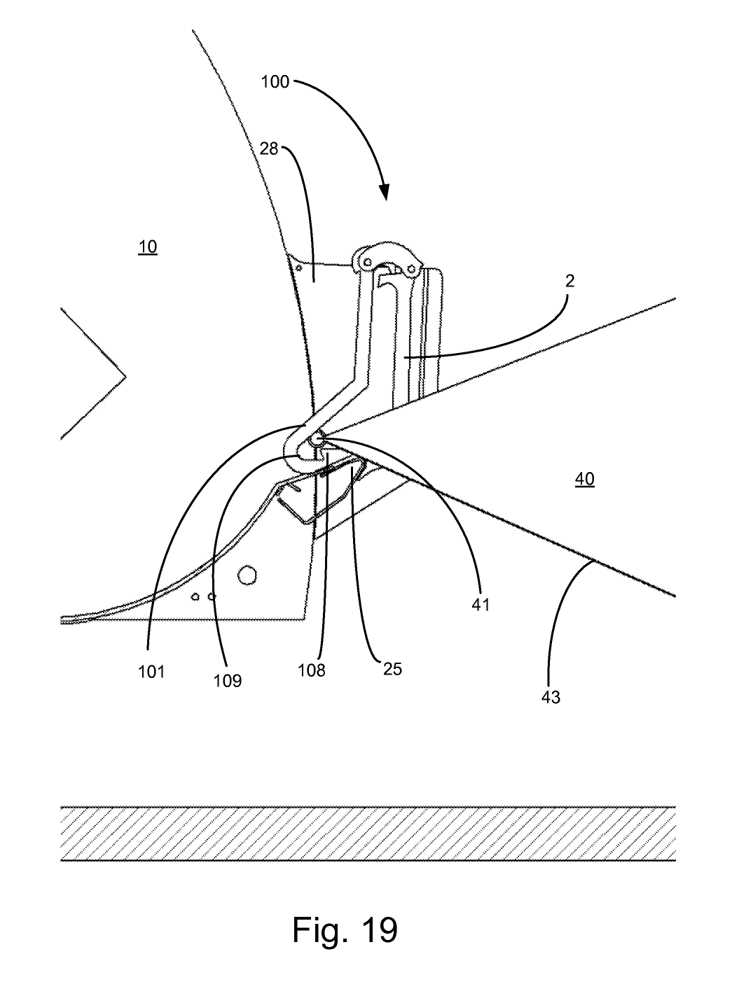

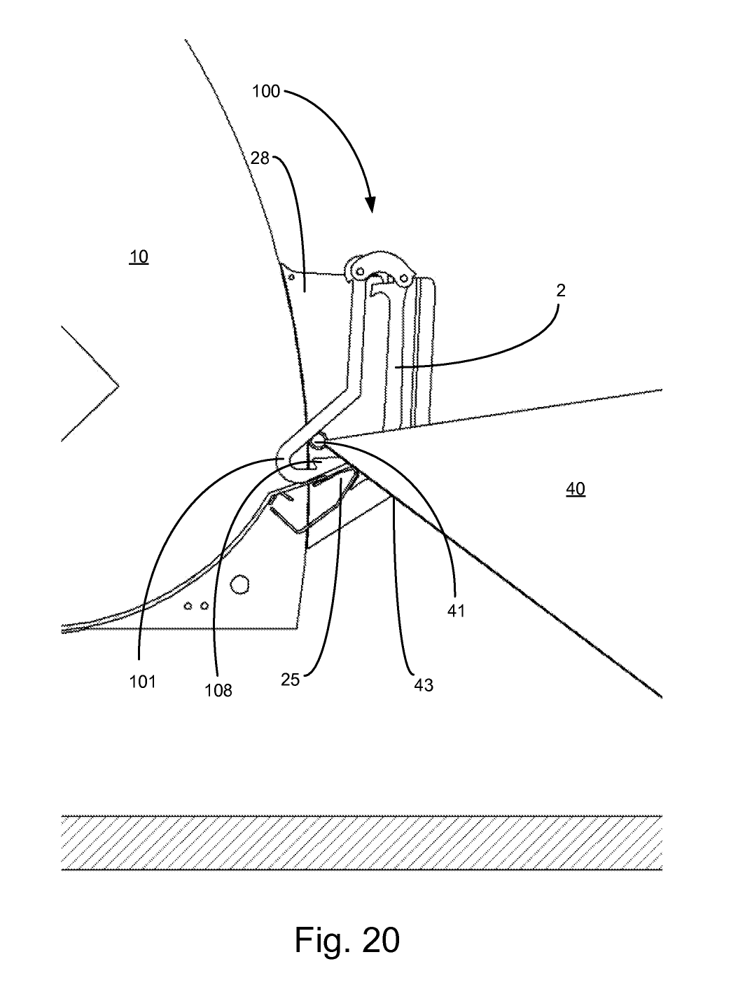

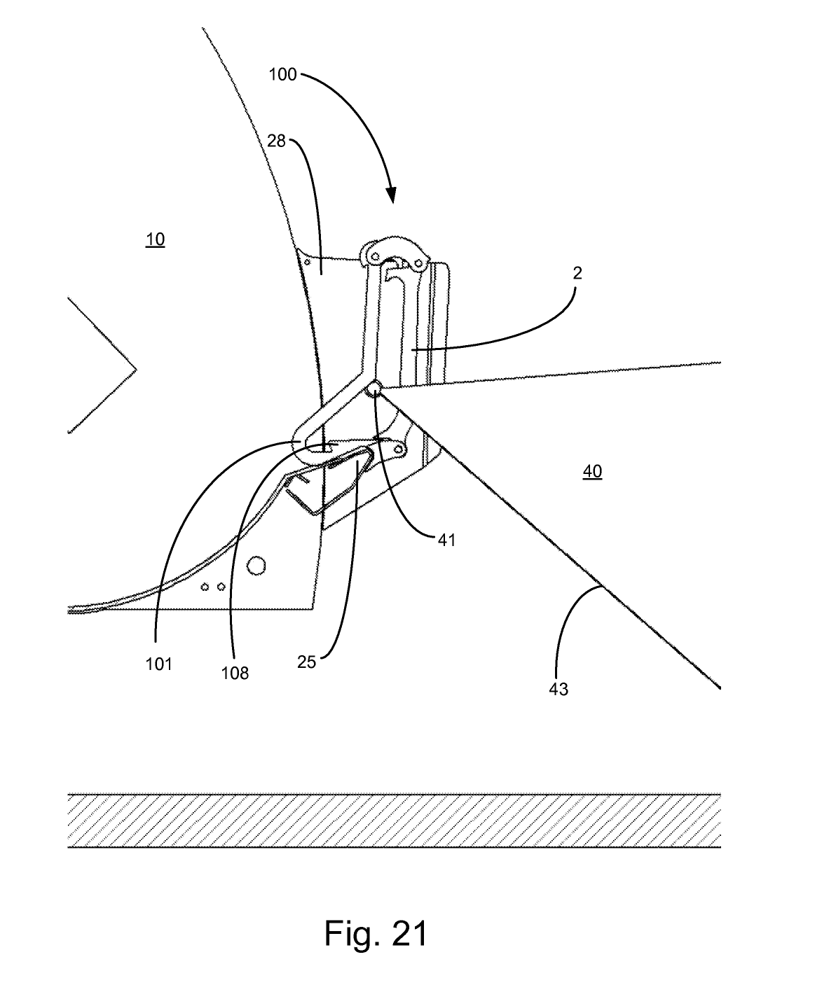

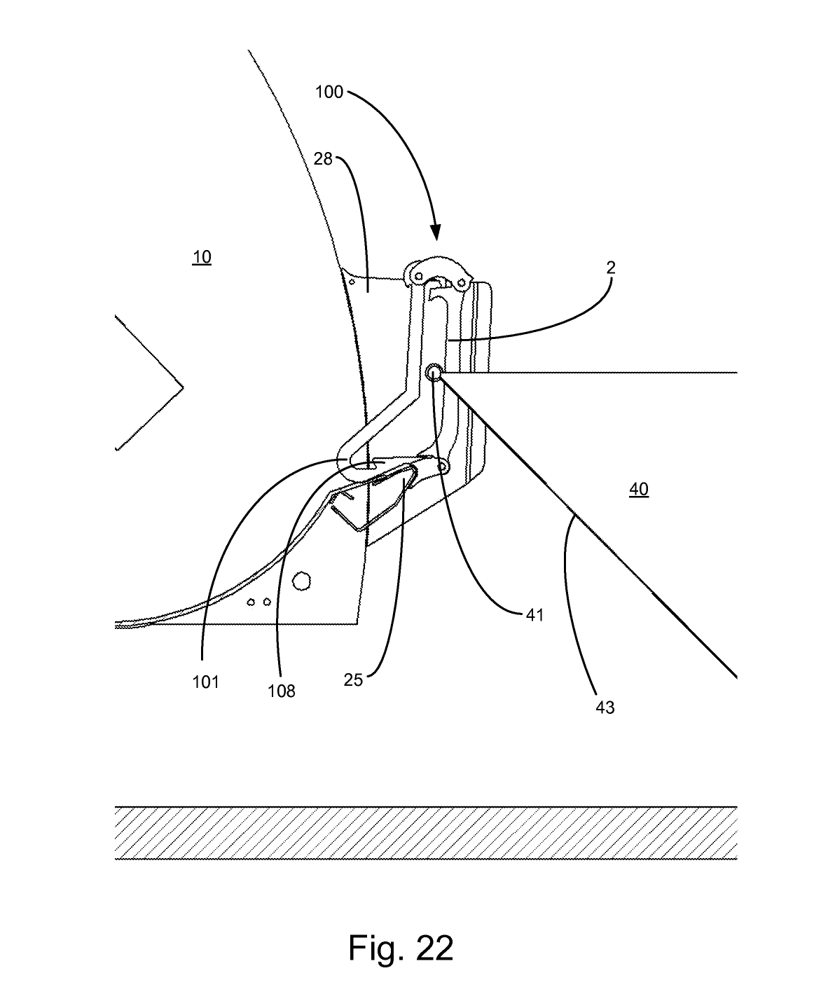

FIGS. 18-22 illustrate lowering container 40 and the coincident extraction of trunnion bar 41 from trunnion pocket 109 of trunnion bar retention system 100. As container 40 is lowered, as shown in FIG. 18, eventually wall 43 of container 40 may contact hopper lip 25 and container 40 may then pivot about a fulcrum at the contact point between hopper lip 25 and container 40. This different fulcrum point may allow trunnion bar 41 to move upward past stop 108 until it hits the top portion of the holding piece 101 which continues to move the trunnion rearward and out of trunnion pocket 109. The top of holding piece 101 must be at a steep enough angle such that it will cause this motion. As container 40 continues to lower, trunnion bar 41 may be pushed out of trunnion pocket 109 until a bottom edge of container contacts the ground The trunnion may then rotate about the front edge of the container 40 until container 40 is completely lowered. Locking bars 2 may then be released and garbage truck 10 may move on to the next collection site.

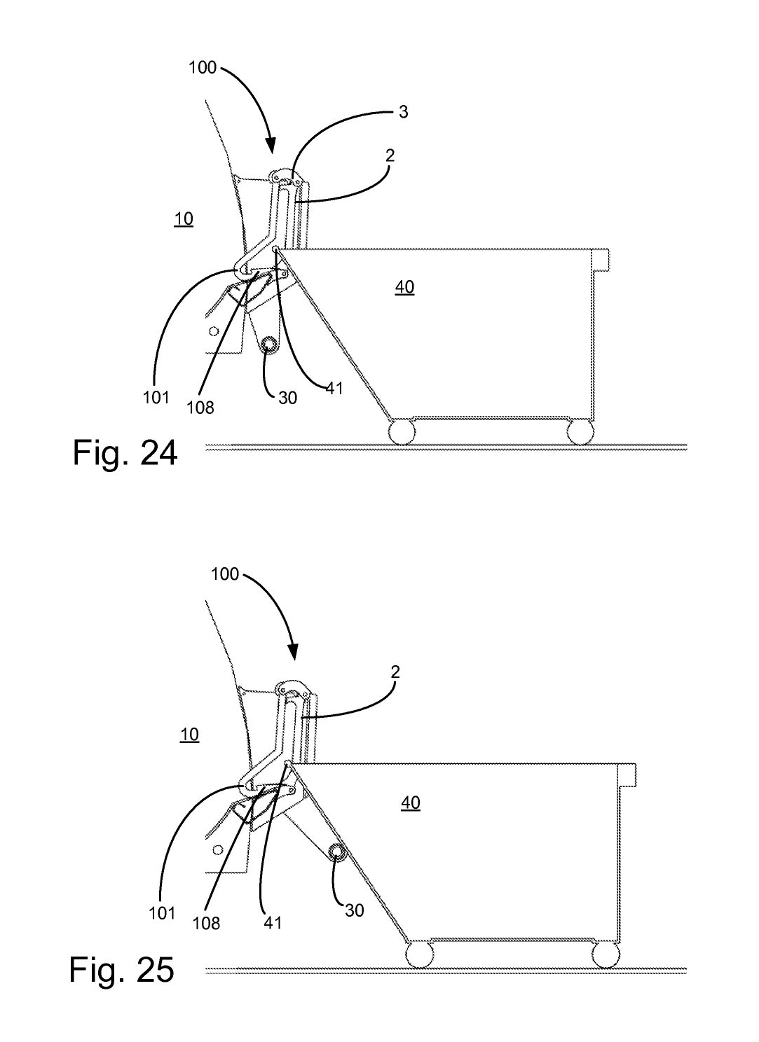

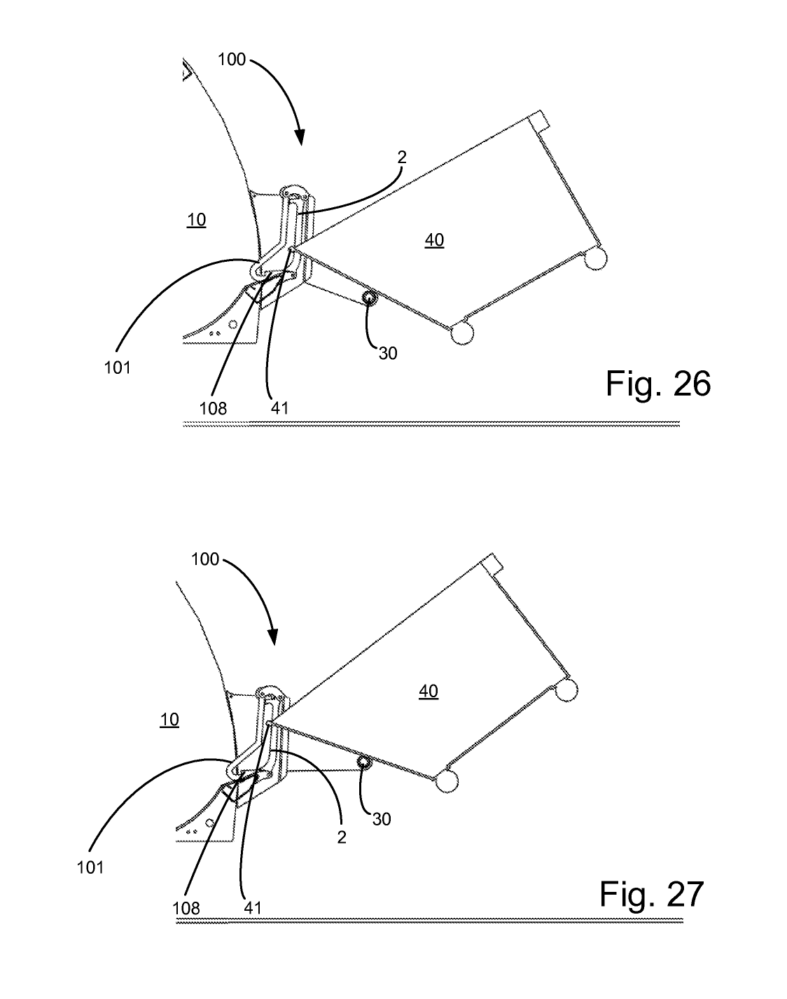

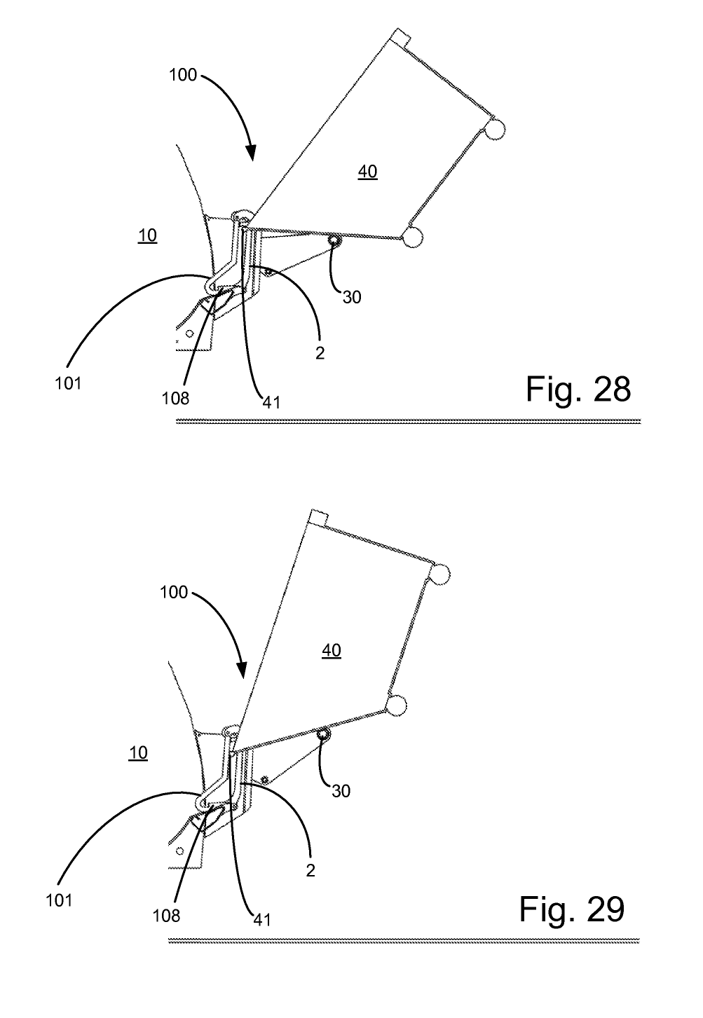

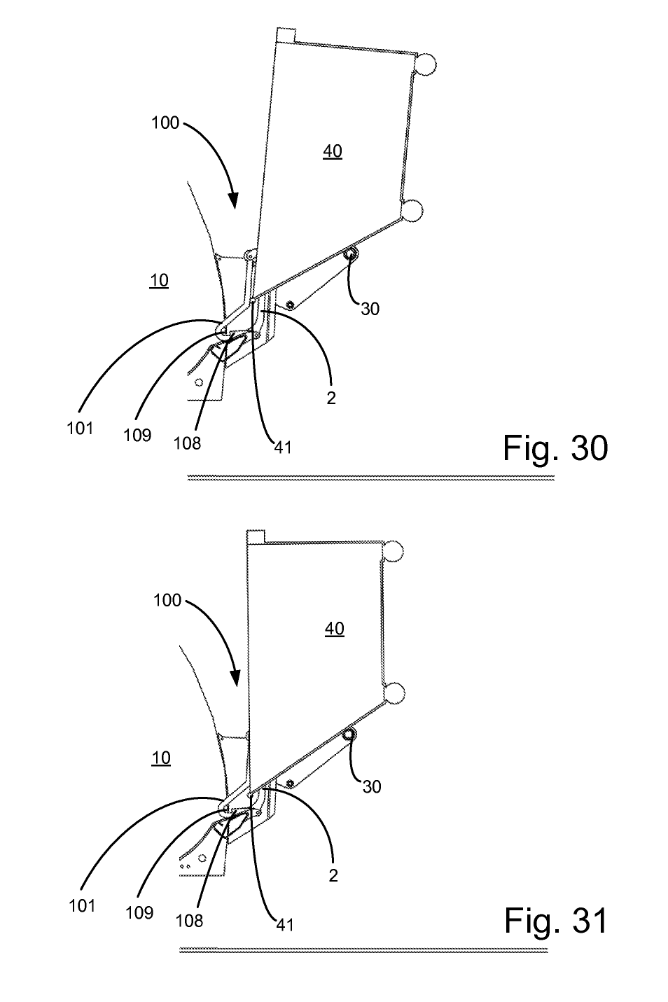

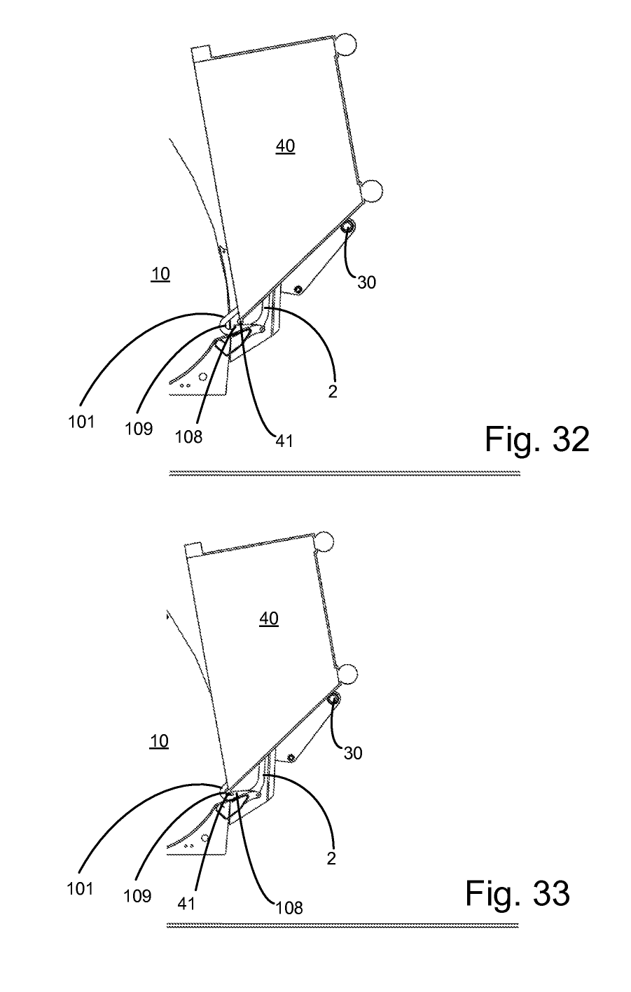

FIGS. 24-33 illustrate another mode of dumping container 40 using trunnion restraing system 100 where rear loading garbage truck 10 may empty smaller commercial containers 40 with tip bar 30, also known as a kick bar, as follows: the driver may approach the container 40 in reverse until trunnion bar 41 of container 40 is close to holding piece 101 of trunnion bar retention system 100 Likewise the driver may move container 40 into a position where trunnion bar 41 of container 40 is close to holding piece 101 of trunnion bar retention system 100. The driver may then secure locking bars 2 around trunnion bar 41 with latch 3. Using hydraulic controls, the driver may then activate tip bar 30 to dump container 40. After container 40 is emptied, the driver may activate the hydraulic contols to lower the container back to the ground.

The forces on the container being raised with the tip bar 30 may be substantially different from when a container is being raised with a winch cable. As the container is initially being raised, tip bar 30 pushes against container 40 and thus towards the rear of the truck. Unlike being raised with the winch cable, if the locking bars 2 are not latched, container 40 will simply be pushed out of trunnion bar retention system 100. As container 40 is further raised with tip bar 30, the forces on the container cause trunnion bar 41 to move up to the top of the slot. Further raising will cause trunnion bar 41 to move down in the slot. It may be important to have a downward slope on the bottom of the trunnion bar retention system 100, including on stop 108, so that trunnion bar 41 will be urged into trunnion pocket 109 at the front. If trunnion bar 41 remains near the edge of hopper lip 25, materials and/or fluids may spill out onto the ground causing an undesireable situation. Stop 108 and trunnion bar pocket 109 may be configured so that trunnion bar 41 cannot be accidently restrained when container 40 is lowered by tip bar 30, and rotates around hopper lip 25.

Similarly, stop 108 may be a separate piece fixedly attached to holding piece 101, or may be integrally formed in holding piece 101. Stop 108 and holding piece 101 may be formed of any material suitable for use with garbage trucks such as iron, steel, other metal alloys, etc. The trunnion bar restraining systems described above may be very valuable in preventing human misery as well as saving significant costs for trucks employing such systems.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. A trunnion bar retention system, comprising:
a pair of holding pieces configured to be coupled to a garbage truck; and
a stop affixed to each of the holding pieces configured to substantially prevent a trunnion bar from exiting the retention system when a container is dumped into the garbage truck, wherein the stop is fixedly attached to the holding piece, the stop and holding piece being formed such that a top surface of the stop slopes downwardly towards the front of the garbage truck.

2. The system of claim 1, wherein the stop and the holding piece form a trunnion pocket.

3. The system of claim 2, wherein the stop includes a portion extending at least 60 degrees from horizontal, the portion forming a side of the trunnion pocket.

4. The system of claim 1, further comprising a locking bar pivotably coupled to each of the pair of holding pieces.

5. The system of claim 4, further comprising a latch coupled to each of the pair of holding pieces, the latches being configured to selectively secure the locking bars to the holding pieces.

6. The system of claim 1, wherien the trunnion bar is fixed to the container.

7. The system of claim 6, wherein the container is a refuse container and the trunnion bar extends from two sides of the container.

8. The system of claim 1, wherein the garbage truck is a rear loading garbage truck.

9. The system of claim 1, wherein each of the holding pieces is generally formed in the shape of a barbed hook, the stop generally forming the barb.

10. A method of dumping a refuse container into a garbage truck, the method comprising:
providing a rear-loading garbage truck having a trunnion bar retention system;
backing the garbage truck to a refuse container having a trunnion bar;
lifting a portion of the refuse container such that trunnion bar contacts a portion of the trunion bar retention system such that the container rotates with respect to the trunnion bar;
sliding the trunnion bar into a trunnion pocket formed in the trunnion bar retention system with a holding piece and a stop, the stop being formed such that the trunnion bar cannot slide out of the trunnion bar retention system when the trunnion bar is bearing the weight of the refuse container; and
lowering the refuse container until a portion of the refuse container other than the trunnion bar pivots against a portion of the garbage truck lifting the trunnion bar out of the trunnion pocket, the stop being formed such that the trunnion bar cannot be vertically restrained when the container pivots about a portion of the garbage truck.

11. The method of claim 10, wherein the trunnion bar retention system includes: a locking bar pivotably coupled to each of a pair of holding pieces; and a latch to secure the locking bar from pivoting.

12. The method of claim 11, further comprising: securing the trunnion bar to the garbage truck with the locking bar and the latch.

13. The method of claim 12, further comprising: releasing the latch and rotating the locking bar.

14. The method of claim 10, wherien the trunnion bar is fixed to the container.

15. The method of claim 14, wherein the container is a refuse container and the trunnion bar extends from two sides of the container.

16. The method of claim 10, wherein the garbage truck is a rear loading garbage truck.

17. The method of claim 10, wherein the holding piece and stop is generally formed in the shape of a barbed hook.

18. The method of claim 10, wherein the stop includes a portion extending at least 60 degrees from horizontal, the portion forming a wall of the trunnion pocket.

19. A trunnion bar retention system, comprising:
a pair of holding pieces configured to be coupled to a garbage truck; and
a stop formed in each of the holding pieces configured to substantially prevent a trunnion bar from exiting the retention system when a container is dumped into the garbage truck, wherein the stop is fixedly attached to the holding piece, the stop and holding piece forming a trunnion pocket, the trunnion pocket being formed such that the trunnion bar is not restrained from exiting the trunnion pocket vertically when in the trunnion pocket.

20. The system of claim 19, further comprising a locking bar pivotably coupled to each of the pair of holding pieces.

21. The system of claim 20, further comprising a latch coupled to each of the pair of holding pieces, the latches being configured to selectively secure the locking bars to the holding pieces.

22. The system of claim 19, wherien the trunnion bar is fixed to the container.

23. The system of claim 22, wherein the container is a refuse container and the trunnion bar extends from two sides of the container.

24. The system of claim 19, wherein the garbage truck is a rear loading garbage truck.

25. The system of claim 19, wherein each of the holding pieces is generally formed in the shape of a barbed hook, the stop generally forming the barb.
